(19) United States
(12) Patent Application Publication
(10) Pub. No.: US 2012/0160745 A1
(43) Pub. Date: Jun. 28, 2012

(54) FEEDING DEVICE FOR INJECTION MOLDING DEVICE

(75) Inventors: YUAN-LUNG KUO, Tu-Cheng (TW); WEI-LUN HAN, Tu-Cheng (TW)

(73) Assignee: HON HAI PRECISION INDUSTRY CO., LTD., Tu-Cheng (TW)

(21) Appl. No.: 13/092,986

(22) Filed: Apr. 25, 2011

(30) Foreign Application Priority Data
Dec. 24, 2010 (TW) 99145698

(51) Int. Cl. B07B 4/00

(52) U.S. Cl. 209/138

(57) ABSTRACT

A feeding device for an injection molding device includes a hopper, a shaft, a number of blade groups, and a driving device. The hopper defines a central axis and a hole along the central axis, the hole includes an inlet and an outlet opposing the inlet. The shaft is received in the hole along the central axis. The blade groups are arranged along direction of the central axis. Each blade groups includes a number of blades which are substantially located at the same radical cross-section of the shaft. Each blade is connected to the shaft and is tilted to the radical cross-section of the shaft. The driving device is connected to the shaft to rotate the shaft and the blade groups to generate airflow towards the inlet.

### BACKGROUND

1. Technical Field

The present disclosure relates to injection molding devices and, particularly, to a feeding device used in an injection molding device.

2. Description of Related Art

Moldable materials are fed into an injection molding device with a funnel-shaped hopper. However, impurities that are mixed in with the material are also introduced into the injection molding device and are undesirably molded as part of the product, degrading the quality of the product.

Therefore, it is desirable to provide a feeding device for use in injection molding device which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure.

FIG. 1 is an isometric view of a feeding device used in an injection molding device, in accordance with an exemplary embodiment.

FIG. 2 is an exploded view of the feeding device of FIG. 1.

### DETAILED DESCRIPTION

Embodiments of the present disclosure will now be described in detail with reference to the drawings.

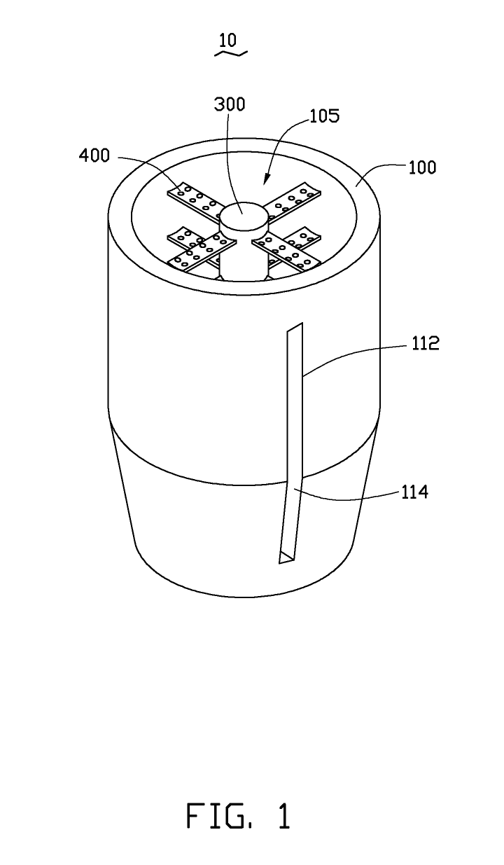

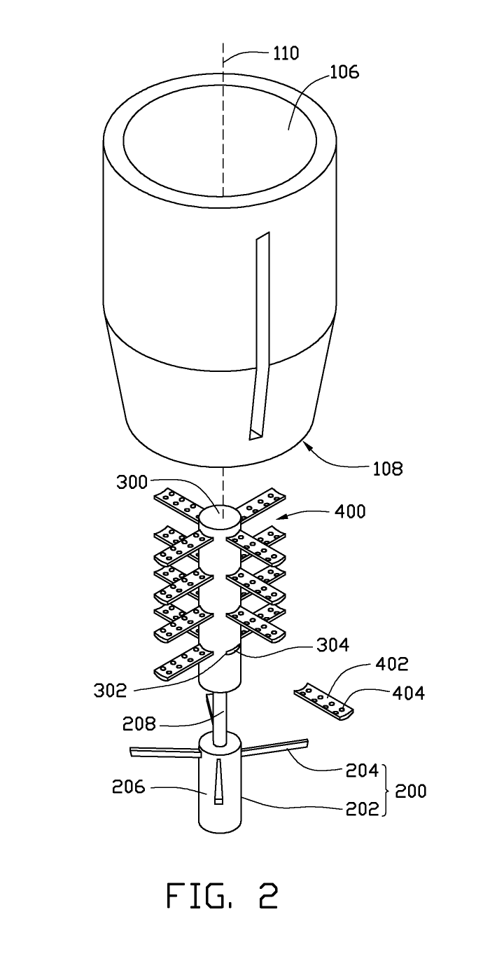

Referring to FIGS. 1 and 2, a feeding device 10, according to an exemplary embodiment, can be used in an injection molding device (not shown) for feeding moldable materials into the injection molding device. The feeding device 10 includes a hopper 100, a driving device 200, a shaft 300, and a number of blade groups 400.

The hopper 100 is substantially funnel-shaped and defines a central axis 110. The hopper 100 defines a hole 105 along the central axis 110. The hole 105 defines an inlet 106 and an outlet 108 opposing the inlet 106.

The driving device 200 includes a motor 202 and four fixing shafts 204. The motor 202 includes a motor body 206 and a motor shaft 208 extending from an end of the motor body 206. The motor body 206 is substantially cylindrical and configured for rotating the motor shaft 208. The four fixing shafts 204 extend from the sidewall of the motor body 206 along the radical direction of the motor body 206 and are equidistantly arranged along the circumferential direction of the motor body 206.

The shaft 300 is substantially cylindrical and defines a number of slot groups 302 on the sidewall thereof. The slot groups 302 are aligned along a direction of the axis of the shaft 300. Each slot group 302 includes four slots 304 that are substantially located at the same radical cross-section of the shaft 300. Each of the slots 304 is tilted with respective to the radical cross-section of the shaft 300.

Each blade group 400 includes four substantially rectangular blades 402.

In assembly, each of the blades 402 is inserted into a corresponding slot 304 so that the blades 402 are connected to the shaft 300 along the radical direction of the hopper 100. An end of the shaft 300 is connected to the motor shaft 20. The four fixing shafts 204 are connected to the inner surface of the hopper 100 such that the motor 200 is arranged adjacent to the outlet 108 and the shaft 300 is arranged along the central axis 110. As such, the driving device 200, the shaft 300, and the blade groups 400 are received in the hopper 100, and the blade groups 400 are aligned along direction of the central axis 110. As each of the blades 402 is tilted with respect to a corresponding cross-section of the shaft 300, each of the blades 402 generates airflow towards the inlet 106 when rotated by the motor 200.

In operation, the feeding device 10 is arranged such that the outlet 108 is vertically connected to the injection molding device. The driving device 200 rotates the shaft 300 about the central axis 110 of the hopper 100. The blade groups 400 generate airflow to the inlet 106. Moldable materials (not shown) are then introduced into hopper 100 via the inlet 106. The materials collide with the blades 402 adjacent to the inlet 106 first. Thus, impurities mixed in the materials and impurities attached to the materials are separated from the materials by the collision. As the blade groups 400 are hierarchically arranged along the shaft 300, airflow generated by the blades 402 under the blades 402 that collide with the materials blow the impurities out of the feeding device 10. As such, impurities introduced into the injection molding device are substantially removed and the quality of the product is improved.

In alternative embodiments, each of the blades 402 can defines a number of through holes 404 that allow the moldable materials to go through. Each of the through holes 404 is arranged along the direction of the central axis 110. When the materials are introduced into the hopper 100, the materials not only collide with the surface of the blades 402, but also collide with the inner surface of the holes 404, which increases the collision between the materials and the blades 402. Therefore, more impurities are blown out of the feeding device 10 and the quality of the product is improved.

In alternative embodiments, the hopper 100 can further include a long hole 112 and a plate 114. The long hole 112 is arranged on the side wall of the hopper 100, extending along a direction of the central axis 110. The plate 114 is transparent and is received in the long hole 112. As such, it is convenient to see how much material is in the hopper 100.

It should be understood that the blades 402 of each blade group 400 is not limited to four as long as each blade group 400 is capable of generating airflow towards the inlet 106.

It will be understood that the above particular embodiments is shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A feeding device for an injection molding device, comprising:
a hopper defining a central axis and a hole along the central axis, the hole comprising an inlet and an outlet opposing the inlet;
a shaft received in the hole along the central axis;
a plurality of blade groups arranged along direction of the central axis; each blade group comprising a plurality of blades which are substantially located at the same radical cross-section of the shaft, each blade being connected to the shaft and being tilted to the radical cross-section of the shaft; and
a driving device connected to the shaft to rotate the shaft and the blade groups to generate airflow towards the inlet.

2. The feeding device of claim 1, wherein the driving device comprises a motor and a plurality of fixing shafts, the motor comprises a motor body and a motor shaft extending from an end of the motor body, the motor body is substantially cylindrical and configured for rotating the motor shaft, each of the fixing shafts extends from the sidewall of the motor body and connects to the inner surface of the hopper, the motor shaft is connected to an end of the shaft.

3. The feeding device of claim 1, wherein each of the blades comprises a plurality of through holes, each through hole is arranged along the direction of the central axis and allows moldable materials to go through.

4. The feeding device of claim 1, wherein the hopper comprises a long hole and a transparent plate, the long hole is defined in the side wall of the hopper along a direction parallel to the central axis, the plate is received in the long hole.
